(19) United States
(12) Patent Application Publication
(10) Pub. No.: US 2009/0216871 A1
(43) Pub. Date: Aug. 27, 2009

(54) MANAGEMENT APPARATUS AND ITS CONTROL METHOD

(75) Inventor: Masatomo Ouchi, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/388,827

(22) Filed: Feb. 19, 2009

(30) Foreign Application Priority Data
Feb. 22, 2008 (JP) 2008-042070

(51) Int. Cl. G06F 15/173

(52) U.S. Cl. 709/223

(57) ABSTRACT

In a managing device in a communication system including both a first terminal that carries out a control procedure with the managing device and starts data communication, and a second terminal that starts data communication without carrying out the control procedure, the start of data communication by the second terminal is recognized. Then, after recognizing the start of the data communication by the second terminal, when the start of a control procedure is requested from the first terminal, the control procedure is changed.

### BACKGROUND OF THE INVENTION

1. Field of the Invention

The present invention relates to a management apparatus and its control method in a communication system which includes both a first terminal that carries out a control procedure with management apparatus and starts data communication, and a second terminal that starts data communication without carrying out the control procedure.

2. Description of the Related Art

Conventionally, the following methods have been available for checking whether or not sufficient bandwidth can be reserved for a transmission channel when streaming videos and the like.

In the first method, a test packet for measuring the status of a transmission channel is sent (for example, Japanese Patent Laid-Open No. 2004-236316 and Japanese Patent Laid-Open No. 2006-279660).

In the second method, information of the status of a transmission channel managed by a base station, a switch, and the like is obtained. For example, in the case of a wireless LAN, the value of the Available Admission Capacity of the QBSS Load specified in IEEE 802.11e is obtained. The QBSS Load is information managed by wireless LAN access points, and is specified as being written in beacons or in probe responses. A wireless LAN terminal can grasp the remaining capacity of the wireless medium by receiving beacons or probe responses.

A modified example of the second method includes, in the case of a wireless LAN, the ADDTS (add Traffic Stream) procedure specified in IEEE 802.11e. This ADDTS procedure is described hereinafter.

First, a wireless LAN terminal sends a request including traffic stream attributes, such as an average speed, to a wireless LAN access point. The access point manages wireless mediums, and therefore gives a positive response or a negative response to the request from terminals or a bandwidth reduction response, depending on the circumstances. When a positive response is given, it is assumed that bandwidth is reserved, and thus the terminal can start communication without measuring the status of transmission channel on its own.

However, there may be a case when a “terminal requesting bandwidth” and a “terminal carrying out streaming without requesting bandwidth” are both included. In such a case, the following problems arise.

A terminal that does not carry out a bandwidth request procedure starts a test procedure, and then carries out content communication. At this point, the base station is not aware that the communication requiring a certain bandwidth is underway. Then, when a terminal that carries out a bandwidth request procedure requests bandwidth, the base station allocates bandwidth. Under such circumstances, when the communication for which the bandwidth request was carried out was of a higher priority control rank, the communication for which bandwidth was not requested is affected. As a result, the test procedure becomes pointless.

Furthermore, when the priority control ranks for the communication for which bandwidth has not been requested and the communication for which bandwidth has been requested are the same, and the total of their communication bandwidths exceed the bandwidth of the transmission channel, both communications are affected.

### SUMMARY OF THE INVENTION

An aspect of the present invention is to improve communication efficiency in a communication system where terminals with different data communication types are both included.

According to one embodiment of the present invention, there is provided a management apparatus in a communication system including both a first terminal that carries out a control procedure with the management apparatus and starts data communication, and a second terminal that starts data communication without carrying out the control procedure. The management apparatus includes a recognition unit that recognizes the start of data communication by the second terminal; and a change unit that changes the control procedure when the start of the control procedure is requested by the first terminal after the recognition unit has recognized the start of data communication by the second terminal.

According to another embodiment of the present invention, there is provided a method for controlling a management apparatus in a communication system including both a first terminal that carries out a control procedure with a management apparatus and starts data communication, and a second terminal that starts data communication without carrying out the control procedure. The method includes recognizing the start of data communication by the second terminal; and changing the control procedure when the start of the control procedure is requested by the first terminal after the start of the data communication by the second terminal has been recognized.

A computer-readable storage medium containing computer-executable instructions for controlling a management apparatus in a communication system including both a first terminal that carries out a control procedure with the management apparatus and starts data communication, and a second terminal that starts data communication without carrying out the control procedure. The medium includes computer-executable instructions for recognizing the start of data communication by the second terminal; and computer-executable instructions that change the control procedure when the start of the control procedure is requested by the first terminal after the recognition unit has recognized the start of data communication by the second terminal.

Further features of the present invention will become apparent from the following description of exemplary embodiments with reference to the attached drawings.

### BRIEF DESCRIPTION OF THE DRAWINGS

FIG. 1 is a diagram illustrating an exemplary configuration of a communication system in a first embodiment.

FIG. 2 is a block diagram illustrating the configuration of a managing device according to an aspect of the present invention.

FIG. 3 is a flowchart illustrating a processing procedure of a managing device according to an aspect of the present invention.

FIG. 4 is a flowchart illustrating a processing procedure of a managing device according to an aspect of the present invention.

FIG. 5 is a flowchart illustrating a processing procedure of a terminal group that carries out a bandwidth request procedure.

FIG. 6 is a flowchart illustrating a processing procedure of a terminal group that does not carry out a bandwidth request procedure.

FIG. 7 is a sequence diagram illustrating communications between a plurality of terminals and a managing device.

FIG. 8 shows diagrams illustrating databases of captured packets and analyses.

FIG. 9 is a diagram illustrating the configuration of a table to which a format of the test procedure is registered.

FIG. 10 is a diagram illustrating a specific example of a throughput display.

### DESCRIPTION OF THE EMBODIMENTS

Embodiments for carrying out the present invention shall be described in detail hereinafter with reference to the drawings.

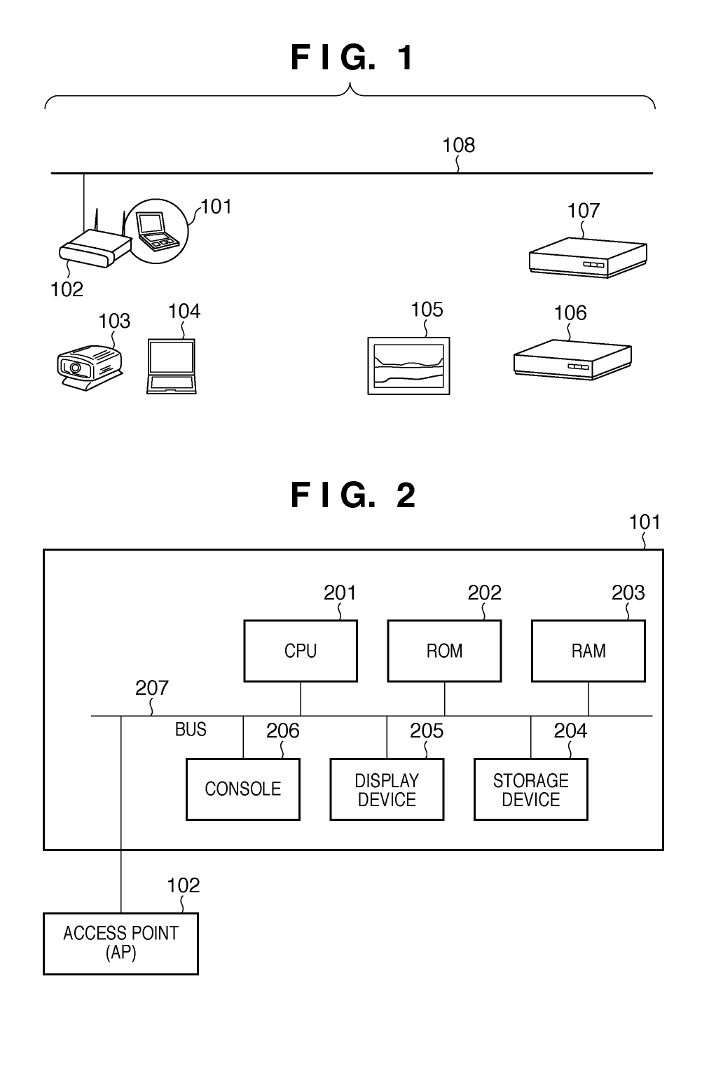

FIG. 1 is a diagram illustrating an exemplary configuration of a communication system in the first embodiment of the present invention (“Embodiment 1”). In FIG. 1, reference numeral 101 is a managing device that takes a leading role in controlling. Reference numeral 102 is an access point (AP). The AP 102 is connected to a wired LAN 108. The managing device 101 and the AP 102 may be configured integrally, or may be configured as separate units. Either way, the managing device 101 is capable of grasping information on the AP 102.

Reference numerals 103 and 105 are both terminals, and carry out a procedure for requesting bandwidth from the managing device 101. The terminals 103 and 105 are also denoted as STA 1 and STA 3, respectively.

Reference numerals 104, 106, and 107 are all terminals, and carry out a test procedure but do not carry out a procedure for requesting bandwidth from the managing device 101. These terminals 104, 106, and 107 are also denoted as STA 2, STA 4, and STA 5, respectively.

In the following, elements of the managing device 101, which is configured separately and connected to the AP 102 via a local bus, are described with reference to FIG. 2.

FIG. 2 is a block diagram illustrating the configuration of a managing device in Embodiment 1. In the configuration of FIG. 2, a CPU 201 controls the entire managing device 101 according to programs and parameters to be mentioned later. A ROM 202 is a semiconductor memory for storing programs, parameters, and the like that do not have to be changed. A RAM 203 is a memory for temporarily storing various programs and data supplied from an external device and the like.

A storage device 204 stores application programs and the like to be executed out by the managing device 101. The storage device 204 is configured of, for example, a hard disk (HDD) or a memory card that is fixedly installed in the managing device 101. The storage device 204 may also include a flexible disk (FD), a Compact Disc (CD), an optical disk such as a DVD, a magnetic card, an optical card, a smartcard (an IC card), a memory card, or the like that is removable from the managing device 101.

The display device 205 is configured of, for example, a liquid crystal display, and displays data held by the device in which the managing device 101 is installed, supplied data, and the like. Reference numeral 206 is a console, configured of a pointing device, a keyboard, and the like.

Each of the above-described elements is connected to a bus 207, and the AP 102 is also connected to the bus 207.

An operation of a communication system configured as described above, which includes both a first terminal that carries out control procedure with the managing device 101 and a second terminal that carries out a measurement without carrying out a control procedure and starts streaming according to the result of the measurement, shall now be described. “Control procedure” refers to a bandwidth request procedure in which bandwidth necessary for the data communication is requested (that is, a communication quality establishing procedure that establishes communication quality). “Communication quality” is at least one of an average speed, a maximum speed, and a minimum speed of communication.

“First terminal” refers to the terminal 103 (STA 1) and the terminal 105 (STA 3) that carry out data communication after carrying out a control procedure with the managing device 101. “Second terminal” refers to the terminal 104 (STA 2), the terminal 106 (STA 4), and the terminal 107 (STA 5) that measures the transmission channel and then carry out data communication based on the result of the measurement.

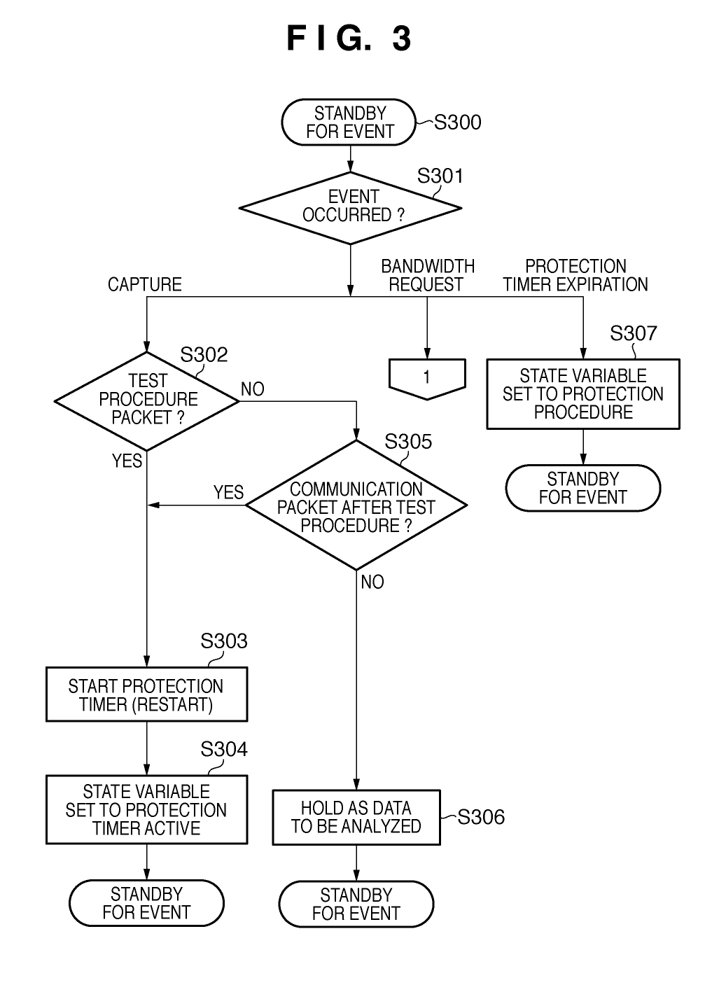

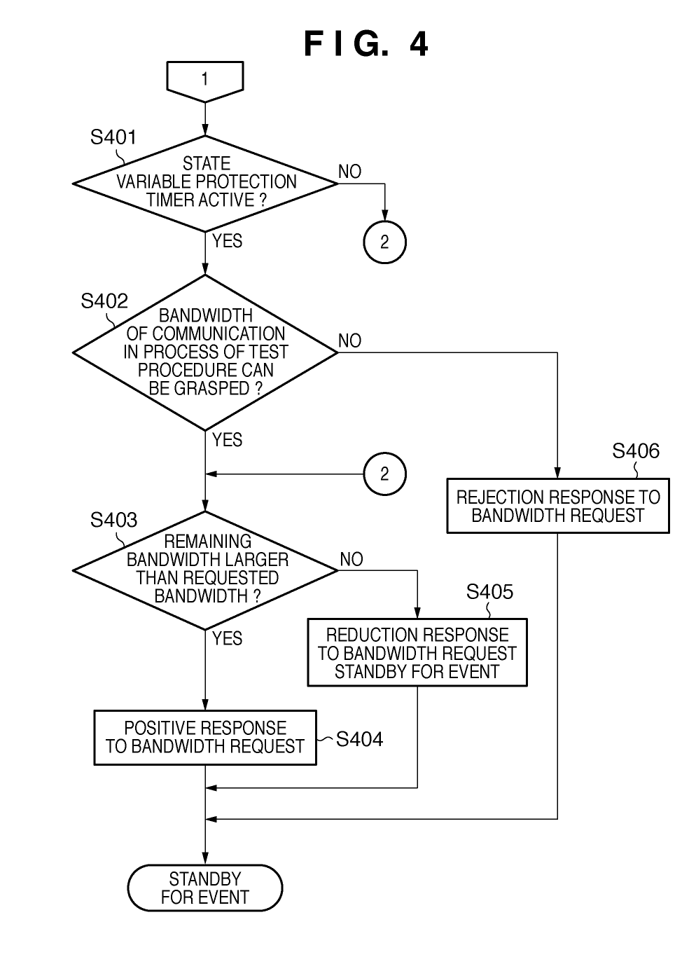

FIG. 3 and FIG. 4 are flowcharts illustrating a processing procedure of the managing device 101 in Embodiment 1. In the following descriptions, the managing device 101 and the AP 102 are closely connected, and the processing procedure of the managing device 101 and the processing procedure of the AP 102 are not clearly distinguished. That is, it is assumed that what is recognized by the AP 102 is also recognized by the managing device 101 as is.

It is assumed that the managing device 101 has already gone through an initializing process. The initializing process refers to, for example, setting a “state variable that indicates whether or not a terminal that is carrying out a test procedure is present” to a value that indicates “pre-test procedure”. Also, it is assumed that each of the terminals STA 1 to STA 5 has already gone through an associating process (connecting process) with the AP 102.

After completing aforementioned initializing process, the managing device 101 waits for an event such as a user's operation or a request from a terminal (S300), and monitors for an event occurrence (S301). Here, it is assumed that the STA 2 in the system has started a test procedure. Since the AP 102 captures all the communication packets, the AP 102 determines that a capturing event has occurred, and thus notifies the managing device 101.

At this point, the managing device 101 does not hold information on the test procedure or the content communication, and therefore the determinations made in S302 and S305 are both “NO”, and the captured data is held for analysis (S306). Then, the process returns to a status where the device stands by for an event (S300). At this point, the managing device 101 continues the operation for holding the packets handled in this test procedure for a certain period of time or for holding a certain amount of packets. Afterwards, when there is no empty space in the memory, the operation for holding is stopped or the packets are overwritten.

Then, the STA 2 starts streaming, that is, starts content communication. The length of streaming communication is usually constant, and a certain port as determined by TCP or UDP is often used. In the test procedure and the content communication, the source-destination pair is the same. Therefore, in those two sets of communication occurring in a certain time frame and having certain regularity, it can be assumed that “the first instance is a test procedure for measuring the transmission channel, and the instance that follows is content communication”.

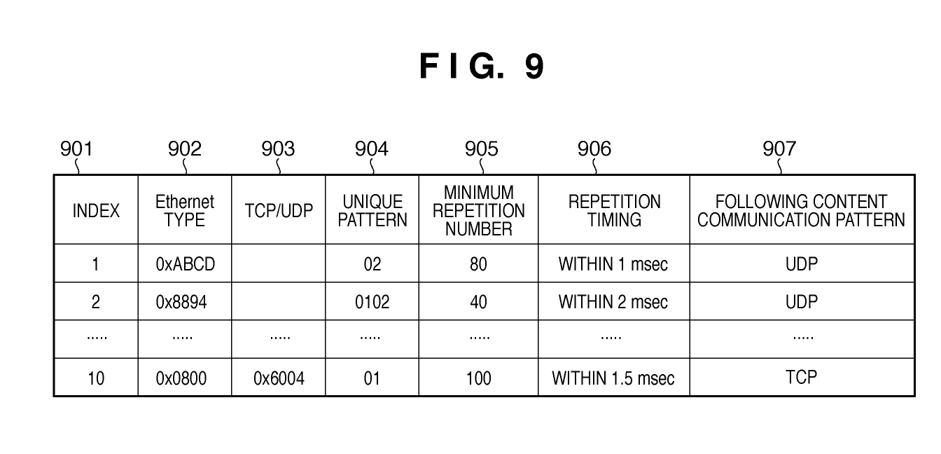

Regularity in the test procedure is registered as shown in FIG. 9. The regularity in this case refers to 902 to 906 in FIG. 9, and 907 is a result of analyzing the regularity. In this example, the analysis is carried out based on an Ethernet® type 902, a TCP/UDP port 903, a unique pattern (a fixed value of a fixed position in the payload) 904, a minimum repetition number 905, and a repetition timing 906.

The first pattern shown in FIG. 9 shall now be described in detail. The first pattern shows that the Ethernet® type 902 is 0xABCD, the unique pattern 904 is 02, the minimum repetition number is 80 times, the repetition timing 906 is within 1 millisecond, and the following content communication pattern 907 is UDP communication. It also shows that a series of communication is considered to be a pattern. This corresponds to the specific processing indicated in S306.

Referring back to FIG. 3, it is assumed that a test procedure and the content communication that follows are executed several times, and a pattern as shown in FIG. 9 is registered at this point. At this time, when the STA 2 starts a test procedure, the managing device 101 determines that the procedure is a test procedure (YES in S302), and starts control that is different from the initial state, that is, starts a protection timer (S303). Then, a state variable that manages the system status is set to “protection timer active” (S304), and the process returns to a status where the device stands by for an event (S300).

Next, it is assumed that the STA 1 has started a bandwidth request procedure in order to communicate with the STA 3. Through this, the managing device 101 acknowledges an event occurrence in S301, and because the event was a bandwidth request, the managing device 101 checks a state variable of the system in S401 shown in FIG. 4. In this case, because the STA 2 has already started the test procedure, the state variable is “protection timer active”. Therefore, the process moves to S402, and the bandwidth for the communication to be carried out later by the terminal that is in the process of the test procedure is estimated. When the managing device 101 does not know what kind of communication is to be actually carried out in the following content communication, the process moves to S406. In S406, the managing device 101 returns a rejection response in response to the bandwidth request from the STA 1.

Because the bandwidth request from the STA 1 is thus rejected when the STA 2 is in the process of the test procedure, content communication by the STA 2 can be carried out smoothly.

Next, another operation of the managing device 101 shall be described. This operation relates to a case when the managing device 101 can estimate the bandwidth used for the content communication in aforementioned S402. For example, when it is known that the test procedure is number two in an index 901 shown in FIG. 9 and streaming communication of 20 Mbps is to be carried out without failure, the process moves to S403.

That is, when the remaining bandwidth of the wireless medium is 30 Mbps, the bandwidth remaining after the following content communication will be 10 Mbps (30 Mbps-20 Mbps). Therefore, when the remaining bandwidth is larger than the bandwidth demanded by the STA 1, a positive response is given in response to the bandwidth request (S404).

When the bandwidth requested by the STA 1 is 12 Mbps, because the request cannot be accepted, a reduction response indicating, for example, “10 Mbps can be allocated” is given (S405).

Referring back to FIG. 3, when the event that occurred was a protection timer expiration, the state variable is set to a protection procedure (S307), and the process returns to a status where the device stands for an event (S300).

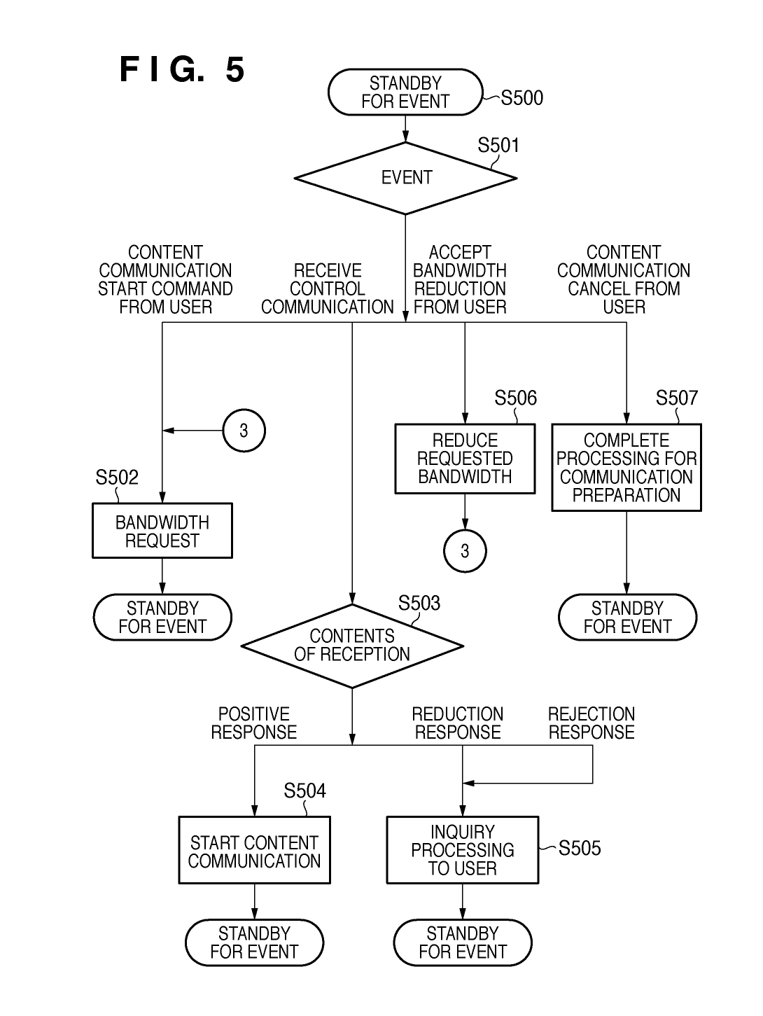

The above is the processing procedure of the managing device 101. Next, the processing procedure on the terminal side is described. FIG. 5 is a flowchart illustrating a processing procedure of a terminal group that carries out a bandwidth request procedure. The configuration of the STA 1 and the STA 3 in the terminal group is basically the same as the configuration of the managing device 101.

First, as described in the processing procedure of the managing device 101, the process starts from a status where the device stands by for an event (S500). Then, when an event is detected (S501), the process branches depending on the details of the event.

An event that is a content communication start command from a user occurs when the STA 1 has given an instruction for a start of communication such as streaming. The STA 1 carries out a procedure for reserving bandwidth that is necessary for the communication for which an instruction has been given by the user. That is, a bandwidth request is sent to the AP 102 in S502. In this example, because the managing device 101 is configured so as to be integrated with the AP 102, a request to the AP 102 is synonymous with a request to the managing device 101. From the terminal side, the bandwidth request is issued to the AP 102, but from the system side, the managing device 101 is making a response via the AP 102. Then, the STA 1 waits for a response from the AP 102.

Next, in S501, if the event is reception of control information from the AP 102, the STA 1 makes a determination regarding the details of the information (S503). If the control information is a positive response to the bandwidth request from the AP 102 as a result of the determination, content communication is started (S504). However, if the control information is a reduction response or a rejection response made in response to the bandwidth request from the AP 102, the response is shown to the user in a fashion that is understandable to the user, and the user is prompted for the next operation (S505).

When the next operation from the user is a command of “bandwidth reduction acceptance”, the STA 1 sets the command value of the bandwidth that is reduced than before (S506). Then, the bandwidth request is sent again with that value (S502).

When the command from the user is “content communication cancel”, the STA 1 carries out processing such as releasing resources reserved for content communication (S507).

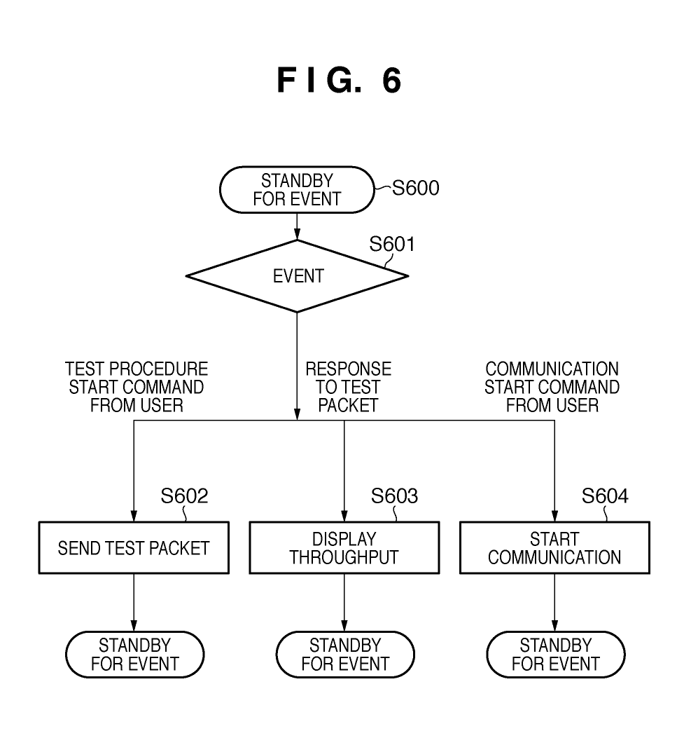

FIG. 6 is a flowchart illustrating a processing procedure of a terminal group that does not carry out a bandwidth request procedure. The STA 2, the STA 4, and the STA 5 in the terminal group are also in a status where they are standing by for an event, similar to the managing device 101 and the STA 1.

First, the process starts with a standby status for an event (S600). Then, when an event is detected (S601), the process branches depending on the event content.

If the event is “a test procedure start command from the user”, the STA 2 starts sending a test packet (S602). In this example, a test packet is sent from, for example, the STA 2 to the STA 4. The items to be measured with the test packet are throughput between the STA 2 and the STA 4 (end to end), delay, jitter, errors, and the like. The test procedure is described further in detail hereinafter.

When a packet in a predetermined format is sent from the STA 2 to the STA 4, the STA 4 responds. These sent and received packets include a time stamp, and the STA 2 is configured so as to be capable of calculating the throughput, the delay, and the jitter from the RTT (Round Trip Time). A sequence number is also included, and the STA 2 is capable of grasping the packet loss rate, that is, the error rate.

If the STA 4 responds to the test packet, the event is “response to test packet”, and the throughput and the like are displayed (S603).

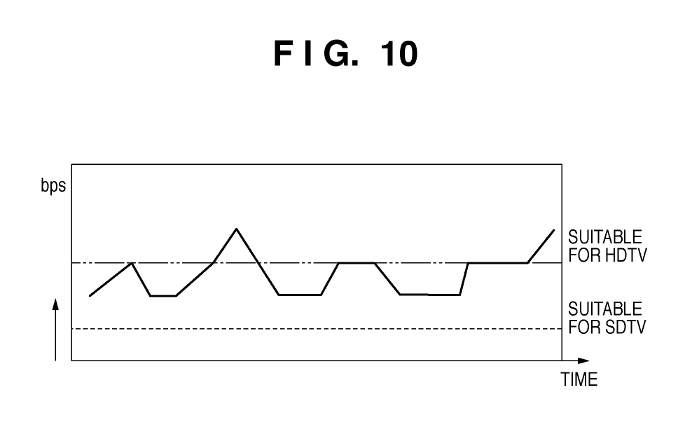

FIG. 10 is a diagram illustrating a specific example of a throughput display. As shown in FIG. 10, for every measurement, time is plotted on the horizontal axis, and the throughput (unit: Mbps) is plotted on the vertical axis. In this example, the display is made so that a user can determine whether the throughput that can be reserved is suitable for high definition television (HDTV) or for standard definition television (SDTV).

Referring back to FIG. 6, if the event is “a communication start instruction from the user”, content communication is started (S604).

As described above, because the test procedure started by the STA 2 can be handled as equivalent to the procedure for the bandwidth request, communication quality is improved, and more types of terminals can be accommodated in a system, increasing the usability thereof.

Next, a second embodiment of the present invention (“Embodiment 2”) according to the present invention shall be described in detail with reference to the figures. In Embodiment 2, the essence of the present invention shall be described once again with an STA 5, that is, a terminal 107 that does not issue a bandwidth request, added. Descriptions for those elements described in Embodiment 1 shall be omitted.

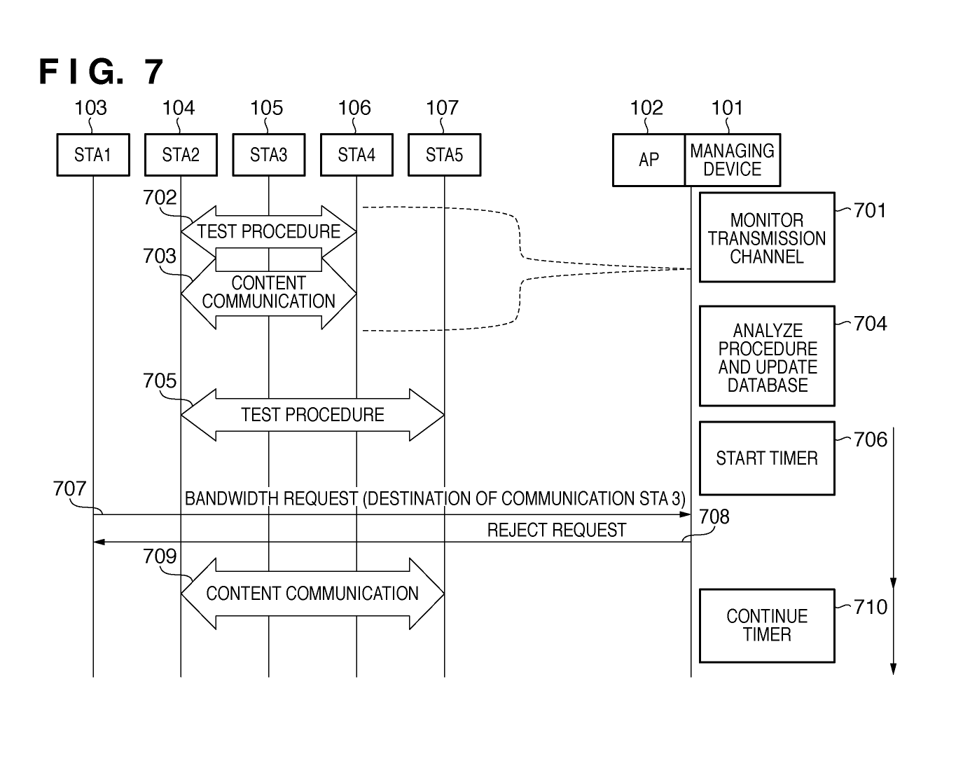

FIG. 7 is a sequence diagram illustrating communication between a plurality of terminals and a managing device. In the diagram, the processing procedure of each terminal is summarized. Reference numerals 101 to 107 correspond to those in the communication system shown in FIG. 1.

First, in its initial state, the five terminals, that is, the STA 1 to STA 5, are associated with the AP 102 and capable of communicating with each other. A managing device 101 starts monitoring packets that are transmitted in this system in such a state (701). “Monitoring” refers to capturing a packet and recognizing the packet format.

Then, the STA 2 starts a test procedure with the STA 4 so as to measure the status of the transmission channel (702). The STA 2 displays the result on the screen while executing the test procedure. For example, the throughput is displayed in real time as a line graph, as shown in FIG. 10. The STA 2 user can determine whether or not sufficient bandwidth can be reserved for the desired content communication from this graph. When the user determines that sufficient throughput can be obtained, content communication is carried out (703).

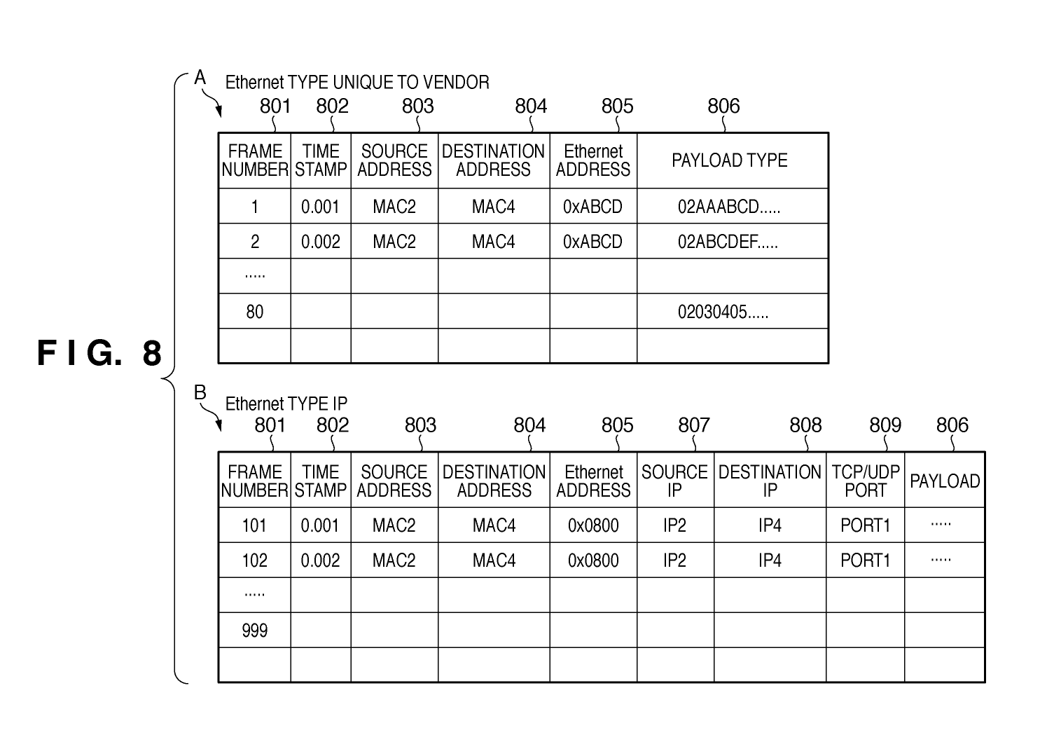

At the same time, the managing device 101 analyzes the test procedure and the following content communication, and stores the analysis in the database as shown in FIG. 8 (704). Determination of whether or not a test procedure is being executed or not is made based on the format of captured packet. Determination of whether or not content communication is carried out is made based on the port number of the IP frame and the time interval of the sending.

FIG. 8 shows diagrams illustrating databases of captured packet and analyses. FIG. 8(A) shows a case where the Ethernet® type is a type which is unique to the vendor, whereas FIG. 8(B) shows a case where the Ethernet® type is an IP type. The database stores a frame number 801, a time stamp 802, a source address 803, a destination address 804, an Ethernet® type 805, and a payload type 806. When the Ethernet® type is the IP type, a source IP 807, a destination IP 808, and a TCP/UDP port 809 are further included.

Afterwards, the STA 2 starts a test procedure with the STA 5 (705). The test procedure is the same as the one executed with the STA 4.

The managing device 101 captures a packet and analyzes whether or not the packet format is the same as the packet format previously determined as being a test procedure. At this point, when the result of the analysis is the same, the managing device 101 predicts that content communication follows thereafter.

Then, the protection timer is reset to its initial value and clocking starts (706). The initial value of the protection timer is a statistical value from the end of the test procedure to the start of the content communication. For the statistical value, the average or maximum value is used.

It is assumed that the STA 1 has started a bandwidth request procedure for communicating with the STA 3 while the timer is in effect (707). Note that the managing device 101 is executing the bandwidth request procedure in collaboration with the AP 102. Thus, the managing device 101 receives a bandwidth request from the STA 1. At this time, the managing device 101 is aware that the STA 2 has started a test procedure, and therefore performs control so as not to allocate bandwidth to other terminals. That is, a rejection response is given in response to this bandwidth request (708).

Then, content communication between the STA 2 and the STA 5 starts (709). When the managing device 101 becomes aware of the content communication, the protection timer continues (710).

Although the managing device 101 and the AP 102 are configured integrally in Embodiments 1 and 2, they may be configured separately as well.

When the managing device 101 and the AP 102 are separate, there may be a case where the managing device includes a wired interface such as Ethernet® or a wireless interface such as a wireless LAN. In either case, control information is exchanged between the managing device and the AP in the same manner as the case with an integrated type.

A plurality of APs may be provided as well. In such a case, when the managing device and the AP are of an integrated type, a plurality of the managing device is provided. The characteristic control of the present invention can be performed in this case as well by making adjustments between the managing devices.

According to the embodiments as described above, the usability can be improved even when various terminals are accommodated in a system. Furthermore, the transmission channel can be effectively utilized without wasteful procedures executed between terminals on their own without the intervention of the managing device.

The present invention may be applied to a system configured of a plurality of devices (e.g., a host computer, an interface device, a reader, a printer, and so on) or to an apparatus configured of a single device (e.g., a copy machine, a facsimile device, and so on).

Furthermore, it goes without saying that the object of the present invention can also be achieved by supplying, to a system or apparatus, a storage medium in which the program code for software that realizes the functions of the aforementioned embodiments has been stored, and causing a computer (CPU or MPU) of the system or apparatus to read out and execute the program code stored in the storage medium.

In such a case, the program code itself read out from the computer-readable storage medium implements the functionality of the aforementioned embodiments, and the storage medium in which the program code is stored composes the present invention.

Examples of a storage medium for supplying the program code include a flexible disk, a hard disk, an optical disk, a magneto-optical disk, a CD-ROM, a CD-R, magnetic tape, a non-volatile memory card, a ROM, and so on.

Moreover, it goes without saying that the following case also falls under the scope of the present invention, which is not limited to implementing the functions of the aforementioned embodiments by a computer executing the read-out program code. That is, the case where an operating system (OS) or the like running in a computer performs part or all of the actual processing based on instructions in the program code, and the functionality of the aforementioned embodiments is realized by that processing, is included in the scope of the present invention.

Furthermore, the program code read out from the storage medium may be written into a memory provided in a function expansion board installed in the computer or a function expansion unit connected to the computer. Then, a CPU or the like included in the function expansion board or expansion unit performs all or part of the actual processing based on instructions included in the program code, and the functions of the aforementioned embodiments may be implemented through that processing. It goes without saying that this also falls within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-042070, filed on Feb. 22, 2008, which is hereby incorporated by reference herein in its entirety.

What is claimed is:

1. A management apparatus in a communication system including both a first terminal that carries out a control procedure with the management apparatus and starts data communication, and a second terminal that starts data communication without carrying out the control procedure, the management apparatus comprising:
a recognition unit that recognizes the start of data communication by the second terminal; and
a change unit that changes the control procedure when the start of the control procedure is requested by the first terminal after the recognition unit has recognized the start of data communication by the second terminal.

2. The apparatus according to claim 1, wherein the recognition unit recognizes the start of data communication by the second terminal when a test procedure that measures a transmission channel is carried out before data communication by the second terminal has started.

3. The apparatus according to claim 1, wherein the change unit rejects the start of the control procedure or changes the contents of the request.

4. The apparatus according to claim 1, wherein the control procedure is a procedure that establishes at least one of an average speed, a maximum speed, and a minimum speed of communication as the communication quality necessary for the data communication.

5. A method for controlling a management apparatus in a communication system including both a first terminal that carries out a control procedure with a management apparatus and starts data communication, and a second terminal that starts data communication without carrying out the control procedure, the method comprising:
recognizing the start of data communication by the second terminal; and
changing the control procedure when the start of the control procedure is requested by the first terminal after the start of the data communication by the second terminal has been recognized.

6. A computer-readable storage medium containing computer-executable instructions for controlling a management apparatus in a communication system including both a first terminal that carries out a control procedure with the management apparatus and starts data communication, and a second terminal that starts data communication without carrying out the control procedure, the medium comprising:
computer-executable instructions for recognizing the start of data communication by the second terminal; and
computer-executable instructions that change the control procedure when the start of the control procedure is requested by the first terminal after the recognition unit has recognized the start of data communication by the second terminal.
